(19) United States
(12) Patent Application Publication
(10) Pub. No.: US 2017/0076244 A1
(43) Pub. Date: Mar. 16, 2017

(54) GENERATING A RECOMMENDATION REGARDING A MEMBER OF AN ORGANIZATION

(71) Applicant: International Business Machines Corporation, Armonk, NY (US)

(72) Inventors: Paul R. Bastide, Boxford, MA (US); Matthew E. Broomhall, Goffstown, NH (US); Sean Callanan, Dublin (IE); Sandra L. Kogan, Newton, MA (US)

(73) Assignee: INTERNATIONAL BUSINESS MACHINES CORPORATION, Armonk, NY (US)

(21) Appl. No.: 14/856,287

(22) Filed: Sep. 16, 2015

(51) Int. Cl. G06Q 10/06

(52) U.S. Cl. CPC G06Q 10/063112

(57) ABSTRACT

Generating a recommendation regarding a member of an organization includes extracting skills data with a corresponding timeline from a database for members of an organization to determine skills for each of the members; creating a skills map, the skills map characterizing relationships between the members and the skills of the members; analyzing one of the skills associated with one of the members in relation to the skills map to make an evaluation; and generating, based on the evaluation, a recommendation regarding at least one of the members of the organization.

### BACKGROUND

The present invention relates to generating a recommendation, and more specifically to generating a recommendation regarding a member of an organization, such as how that member may improve or expand his or her skills.

Each of the members within an organization may have a specific set of skills. The organization will want to know what skills its members have so as to be able to best utilize those skills in its work, whether professional or otherwise. Also, organization members will want to continue to hone and expand their skills in an ever changing business and economic environment.

### BRIEF SUMMARY

A method for generating a recommendation regarding a member of an organization includes extracting skills data with a corresponding timeline from a database for members of an organization to determine skills for each of the members; creating a skills map, the skills map characterizing relationships between the members and the skills of the members; analyzing one of the skills associated with one of the members in relation to the skills map to make an evaluation; and generating, based on the evaluation, a recommendation regarding at least one of the members of the organization.

A system for generating a recommendation regarding a member of an organization includes a processor and computer program code, communicatively coupled to the processor. The computer program code includes an extracting engine to extract skills data with a corresponding timeline from a database for members of the organization to determine skills for each of the members; a creating engine to create a skills map, the skills map illustrating relationships between the members and the skills of the members; an analyzing engine to analyze one of the skills associated with one of the members in relation to the skills map to make an evaluation; and a generating engine to generate, based on the evaluation, a recommendation regarding at least one of the members of the organization.

A machine-readable storage medium encoded with instructions for generating a recommendation regarding a member of an organization includes instructions executable by a processor of a system to cause the system to: extract skills data, including a timeline, from a database for members of an organization to determine skills for each of the members relative to the timeline; analyze skills associated with a number of the members in relation to skills of other members of the organization to generate an analysis; and generate a recommendation regarding a specific member of the organization based on the analysis.

### BRIEF DESCRIPTION OF THE SEVERAL VIEWS OF THE DRAWINGS

The accompanying drawings illustrate various examples of the principles described herein and are a part of the specification. The examples do not limit the scope of the claims.

FIG. 1 is a diagram of an example of a system for generating a recommendation regarding a member of an organization, according to one example of principles described herein.

FIG. 2 is a diagram of an example of a system for generating a recommendation regarding a member of an organization, according to one example of principles described herein.

FIG. 3 is a diagram of an example of a skills map, according to one example of principles described herein.

FIG. 4 is a flowchart of an example of a method for generating a recommendation regarding a member of an organization, according to one example of principles described herein.

FIG. 5 is a flowchart of an example of a method for generating a recommendation regarding a member of an organization, according to one example of principles described herein.

FIG. 6 is a diagram of an example of a generating system, according to the principles described herein.

FIG. 7 is a diagram of an example of a generating system, according to the principles described herein.

Throughout the drawings, identical reference numbers designate similar, but not necessarily identical, elements.

### DETAILED DESCRIPTION

The present specification describes a method and system for generating a recommendation regarding a member of an organization. For example, the recommendation may indicate how a member can use a skill, gain a new skill, or improve upon a skill.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As noted above, each of the members within an organization may have a specific set of skills. Data relating to the specific skill set for each member may be stored in a database as skills data. Typically, the skills data is generated via surveys about a member's skills. The survey may be completed by the member, a manager of the member, or other members of an organization. Once the survey is complete, the information from the survey is stored in the database to document the skill set of each member.

Alternatively, the skills data may be generated via a social network. The social network may allow users of the social network to create endorsements for members of an organization. The endorsement may indicate that a member has obtained a specific skill. Once the endorsement is made, the endorsement is stored in the database as skills data for that member.

In practice, the skills data may be retrieved from the database and analyzed, for example, to form successful teams, aid in team building, determine member performance, determine career growth, determine training, and to realize other objectives within the organization. Thus, the skills data may be used to identify which members of an organization may utilize their skills to realize an objective set by the organization. Additionally, as disclosed herein, the skills database may also be used to plan for members to enhance their skills or acquire new skills, including using other members of the organization to transmit new or improved skills to a member for whom skill set enhancement is being planned or recommended.

In the present specification and in the appended claims, the term “skills data” means data relating to a member's skills. The skills data may include a timeline, a skill, a job title, a job role, other skills data, or combinations thereof.

In the present specification and in the appended claims, the term “skills map” means a visual representation describing relationships between members of an organization and their skills. The members and skills may be represented as nodes on the skills map. Relationships between the members and the skills may be represented as edges on the skills map.

In the present specification and in the appended claims, the term “evaluation” means a determination of a member's skills. The evaluation may be based on an analysis of skills data, a timeline, and/or historic data.

In the present specification and in the appended claims, the term “recommendation” means a suggestion to allow a member of an organization to use a skill, to gain a skill or to improve upon a skill. The recommendation may be generated based on an event or a specific time.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

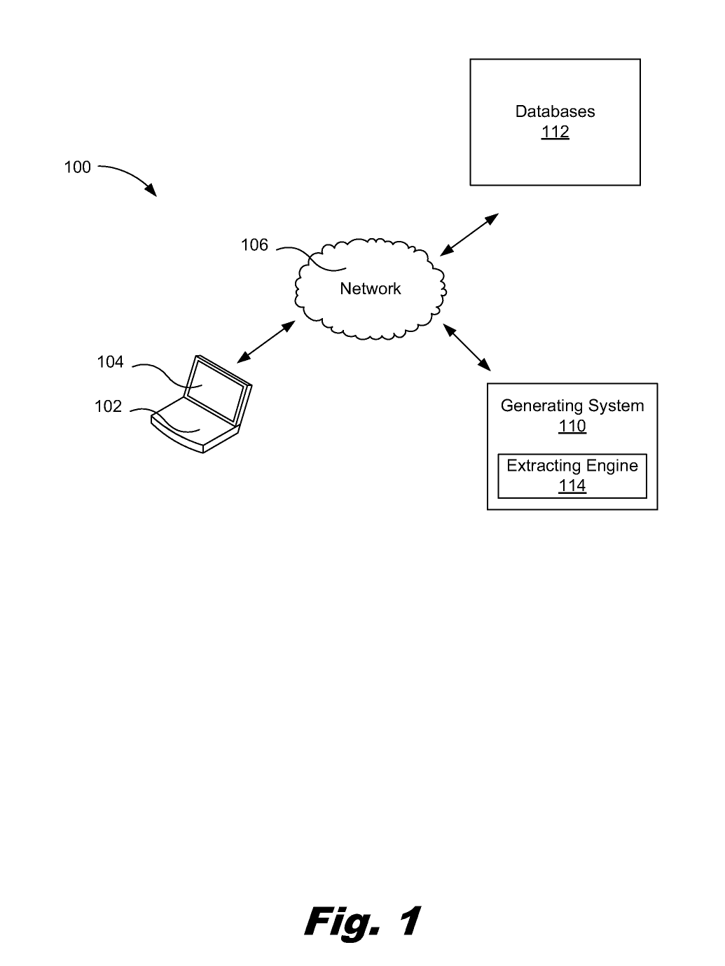

Referring now to the figures, FIG. 1 is a diagram of an example of a system for generating a recommendation regarding a member of an organization, This recommendation, for example, may indicate what skills the member should improve or acquire and may also suggest a mentor member in the organization who can assist the member in doing so. Alternatively, a recommendation may indicate what member of an organization is suited for work on a particular objective of the organization.

As will be described below, a generating system is in communication with a network to extract skills data with a corresponding timeline from databases for members of an organization to determine skills for each of the members. The generating system creates a skills map, the skills map characterizing relationships between the members and the skills of the members. The generating system analyzes one of the skills associated with one of the members in relation to the skills map to make an evaluation. The generating system generates, based on the evaluation, a recommendation regarding at least one of the members of the organization.

As illustrated, the system (100) includes a user device (102) with a display (104). The user device (102) allows an administrator to select a member or members of an organization for analysis. The user device (102) has access to a network (106) over which the device (102) can access the database (112) of skills data. As will be described below, the skills data for the members that are selected is analyzed to determine which members can use a skill, gain a skill, improve upon a skill, or combinations thereof. The display (104) of the user device (102) may display members for selection and/or recommendations via a graphical user interface (GUI). More information about the user device (102) will be described in other parts of this specification.

As indicated, the system (100) includes database (112) of skills data for members of an organization. This database (112) may include data from any number of sources, which may or may not be organized into separate databases, such as a social networking database, a human resource (HR) database, a user profile database, other databases, or combinations thereof. For each member of the organization, the skills data may include such items as a listing of skills, a timeline of skill usage or acquisition, a job title, a job role, other skills data, or combinations thereof. More information about the databases (112) will be described in other parts of this specification.

The system (100) includes a generating system (110). The generating system (110) may be in communication with the user device (102) and the databases (112) over the network (106). In the illustrated example, the generating system (110) extracts skills data for members of the organization.

Further, the generating system (110) then creates a skills map that characterizes relationships between the members and the skills of the members. As illustrated, a creating engine (114) creates the skills map. As will be described below, the skills map may include weighted edges to indicate how current each of the skills for each of the members is.

The generating system (110) analyzes one of the skills associated with one of the members in relation to the skills map to make an evaluation. The evaluation may be used for a variety of purposes leading to a recommendation regarding the corresponding member of the organization. For example, the evaluation may be used to determine the likelihood of a member obtaining a new skill; the likelihood of a member improving a certain skill, or simply for a talent or skills analysis of the member or the member's potential. For example, if a newer organization member has a skills profile similar to that of a number of older organization members at an earlier point in time, it can be assumed that the newer organization member is like to acquire the same skills that the older organization members subsequently acquired. Thus, the skill sets developed by the older organization members from a starting point similar to where a newer organization member now is can be used as a guide to how the skill set of the newer organization member can, should or is likely to evolve.

Consequently, the generating system (110) generates, based on the evaluation, a recommendation regarding the member analyzed. In this way, for example, the organization can monitor whether its members have evolving and relevant skills and how to encourage such skill development. More information about the generating system (110) will be described later on in this specification.

While this example has been described with reference to the generating system being located over the network, the generating system may be located in any appropriate location according to the principles described herein. For example, the generating system may be located in a user device, a server, a database, other locations, or combinations thereof.

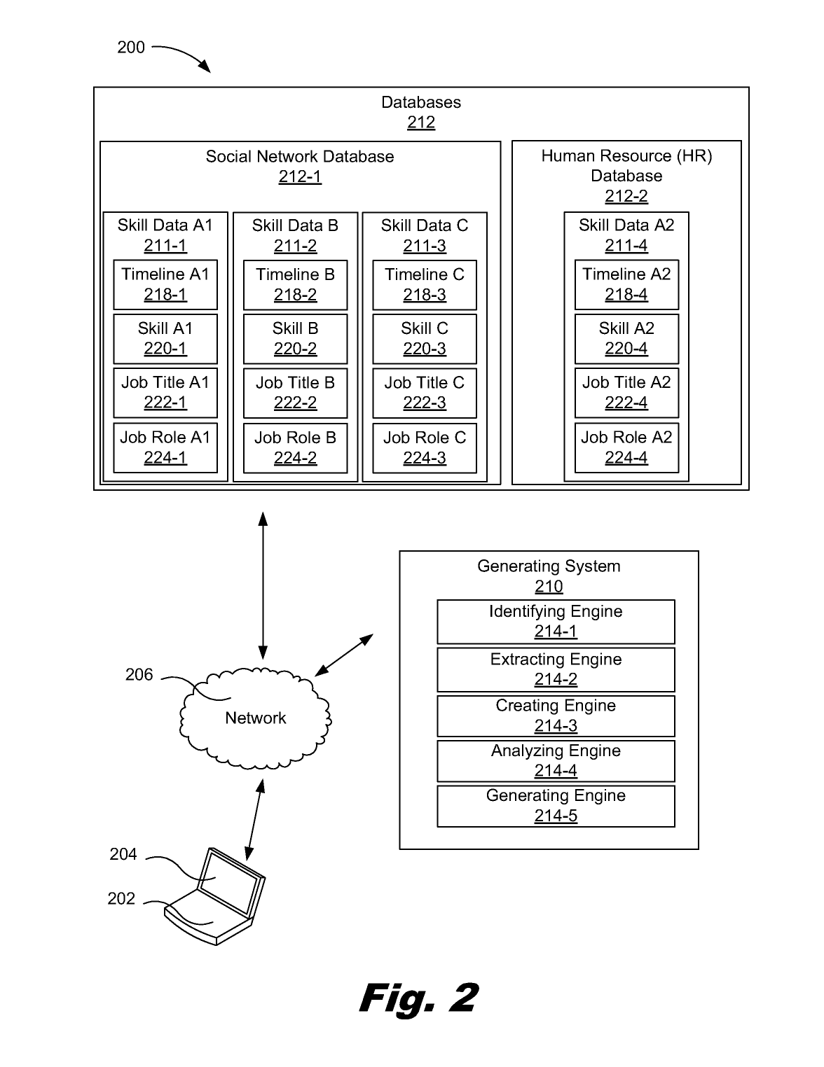

FIG. 2 is a diagram of an example of a system for generating a recommendation regarding a member of an organization, according to one example of principles described herein. As will be described below, the illustrative generating system is in communication with a network to extract skills data with a corresponding timeline from databases for members of an organization to determine skills for each of the members. The generating system creates a skills map, the skills map characterizing relationships between the members and the skills of the members. Further, the generating system analyzes one of the skills associated with one of the members in relation to the skills map to make an evaluation. The generating system generates, based on the evaluation, a recommendation regarding at least one of the members of the organization.

As illustrated the system (200) includes a user device (202) with a display (204). As mentioned above, the user device (202) may allow an administrator to select members of an organization to be analyzed by a generating system (210). In some example, a GUI may be displayed on the display (204). The GUI may include textboxes, radio buttons, and/or check boxes to allow the administrator to select the members for which analysis is desired. As will be described below, the display (204) may eventually display a skill map and one or more recommendations via the GUI.

The system (100) includes databases (112). As illustrated, the databases (212) may include a social network database (212-1). The social network databases (212-1) may include a network-based application to enable members of an organization to create a user account. Once the user account is created, the members establish connections with other members, such as friends, family, and colleagues in an online environment. The member may then send endorsements to other members via the network-based application. The endorsements may indicate that a particular skill has been acquired by a member.

As illustrated, the social network database (212-1) includes skills data (211). For example, the social network database (212-1) includes skill data A1 (211-1), skill data B (211-2), and skill data C (211-3). The skill data (211) may be data that is related to each of the member's skills. The skill data (211) may be associated with each member of an organization. For example, skill data A1 (211-1) may be associated with member A of the organization. Skill data B (211-2) may be associated with member B of the organization. Skill data C (211-3) may be associated with member C of the organization.

The skills data (211) may include a skill (220). The skill (220) may be an indication of a specific skill or type of skill that the member has acquired. For example, skill data A1 (211-1) may include skill A1 (220-1). Skill A1 (220-1) may be a specific skills such as a programming language that member A has acquired. Skill data B (211-2) may include skill B (220-2). Skill B (220-2) may be a specific skill such as a foreign language that member B has acquired. Skill data C (211-3) may include skill C (220-3). Skill C (220-3) may be specific skill such as a negotiation tactic that member C has acquired.

The skills data (211) may include a job title (222). For example, skill data A1 (211-1) may include job title A1 (222-1). Job title A1 (222-1), associated with member A, may be electrical engineer. Skill data B (211-2) may include job title B (222-2). Job title B (222-2), associated with member B, may be senior electrical engineer. Skill data C (211-3) may include job title C (222-3). Job title C (222-3), associated with member C, may be senior software engineer.

The skills data (211) may include a job role (224). For example, skill data A1 (211-1) may include job role A1 (224-1). Job role A1 (224-1), associated with member A, may include designing and assembling electronic circuits. Skill data B (211-2) may include job role B (224-2). Job role B (224-2), associated with member B, may include designing advanced electronic circuits. Skill data C (211-3) may include job role C (224-3). Job role C (224-1), associated with member C, may include designing and writing computer programs.

The skills data (211) may include a timeline (218) to indicate when a skill was acquired by the member. For example, skill data A1 (211-1) may include timeline A1 (218-1). Timeline A1 (218-1) may indicate that member A acquired skill A1 (218-1) on Oct. 23, 2014. Skill data B (211-2) may include timeline B (218-2). Timeline B (218-2) may indicate member B acquired skill B (220-2) on Nov. 8, 2010. Skill data C (211-3) may include timeline C (218-3). Timeline C (218-3) may indicate member C acquired skill C (220-3) on Sep. 25, 2002. While this example has been described with reference to the members acquiring one skill, the members may acquire several skills. Each of the skills that the members have acquired may be included on the timeline. For example, if member B acquired skill D, skill E, and skill F, each of these skill may be included on timeline B (218-2).

As illustrated, the databases (212) may include an HR database (212-2). The HR database (212-2) includes skill data A2 (211-4). Skill data A2 (211-4) may be associated with member A of the organization. Skill data A2 (211-4) may include timeline A2 (218-4), skill A2 (220-4), job title A2 (222-4), and job role A2 (224-4). Timeline A2 (218-4) may indicate that member A acquired skill A2 (218-4) on Oct. 9, 2014. Skill A2 (220-2) may be a specific skills such as a foreign language that member A has acquired. Job title A2 (222-4), associated with member A, may be foreign translator. Job role A2 (224-4), associated with member A, may include translating Spanish documents into English. While this example has been described with reference to two timelines, such as timeline A1 (218-1) and timeline A2 (218-4), being associated with member A, timeline A1 (218-1) and timeline A2 (218-4) may be combined to form a single timeline for member A.

Although not illustrated, the databases (212) may include other types of databases. For example, the other types of databases may include user a resume database, an organizational history database, a member profile database, other databases, or combinations thereof.

The system (200) includes a generating system (210). In one example, the generating system (210) includes a processor and computer program code. The computer program code is communicatively coupled to the processor. The computer program code includes a number of engines (214). The engines (214) refer to program instructions for performing a designated function. The computer program code causes the processor to execute the designated function of the engines (214). In other examples, the engines (214) refer to a combination of hardware and program instructions to perform a designated function. Each of the engines (214) includes, at a minimum, a processor and memory. The program instructions are stored in the memory and cause the processor to execute the designated function of the engine. As illustrated, the generating system (204) includes an identifying engine (214-1), an extracting engine (214-2), a creating engine (214-3), an analyzing engine (214-4), and a generating engine (214-5).

The identifying engine (214-1) identifies, based on an action of an administrator, members of an organization for analysis. The identifying engine (214-1) engine may utilize administrator actions such as a search query with specific search parameters or the individual selection of members of the organization to identify a group of members for analysis. The identifying engine (214-1) may user other actions such as job changes of a member, attrition, onboarding, or other event that changes the structure of the organization to identify the members for analysis. For example, if an organization included member A and member B and the organization now includes member A and member C, the identifying engine (214-1) may identify member C as a new member for whom analysis might be conducted. The identifying engine (214-1) may utilize thresholds of the actions or patterns of the actions for identifying the members to be analyzed.

The members of the organization may be identified for further analysis based on such factors as personal development, career development, an interest, business needs, a team strategy, a job role, an expertise, or combinations thereof. For example, where interest X is relevant for an analysis, the identifying engine (214-1) identifies all members that have interest X. As a result, the members that have interest X are subsequently used by the generating system (210) for analysis.

The extracting engine (214-2) extracts skills data (211) with a corresponding timeline from databases (212) for each of the members of the organization to determine skills for each of the members. For example, the extracting engine (214-2) extracts skill data A1 (211-1) to identify skill A1 (220-1) for member A. Skill A1 (220-1) may be associated with timeline A1 (218-1). Timeline A1 (218-1) may indicate when skill A1 (220-1) was acquired or when skill A1 (220-1) was last used by member A.

The creating engine (214-3) creates a skills map, the skills map characterizing relationships between the members and the skills of the members. The administrator may view the skills map via the display (204) of the user device (202). The skills map may visually represent a relationship between the skills and the selected members. A weight may be applied to the edges of on the skills map to create weighted edges. This indicates when a skill was last used by a member. As a result, the weighted edges indicate how current each of the skills for each of the members is.

In some examples, the creating engine (214-3) identifies the skills map for each of the members in the organization. For example, a skills map may have already been created for a past analysis of member's skills for the organization. This skills map may be stored in a database and used for subsequent analysis of the member's skills. As a result, the creating engine (214-3) may access the database to reuse the skills map for further analysis of the of member's skills instead of creating a new skills map.

The creating engine (214-3) may identify relationships between each of the members. For example, member B and member A may share at least one common skill. As a result, the relationship between member A and member B may be based on a common skill. The relationship may be further based on as a common job title, a common job role, or combinations thereof.

The creating engine (214-3) updates the skills map to include the relationships. For example, a weighted edge on the skills map may be illustrated connecting member A and member B to the common skill if member A and member B were not previously connected to the common skill on the skills map.

.In some examples, the creating engine (214-3) creates a skills map for the organization. As will be described in other parts of the specification, the skills and members are nodes. The relationship between the members and the skills may be represented as a weighted edge, date, and/or title. The skills map may be an ontology or a graph structure to describe the relationships. The skills map may be a custom delivered map that is provided via a specific model. The specific model may be a psychometric model. The psychometric model may be used as an objective measurement of a member's skills, knowledge, attitudes, personality traits, and educational achievements.

The generating system (210) may include an analyzing engine (214-4). As will be described below, the analyzing engine (214-4) may conduct several types of evaluations. Some of the evaluations may be conducted every time the generating system (210) is activated. Other evaluations may be conducted based to an event. The event may include activing the generating system (210) at the discretion of an administrator, at a specific time, when a member acquires a specific skill, when a member acquires a specific job role, when a member becomes a part of an organization, other events, or combinations thereof. The evaluations may be conducted based on a time. The time may be a specific minute, hour, day, week, or year. The evaluations may further be conducted as appropriate as indicated by the specific examples below or by other appropriate factors.

The analyzing engine (214-4) analyzes one of the skills associated with one of the members in relation to the skills map to make an evaluation. The evaluation compares a current skill level for each of the members to the skills that are relevant for realizing a skill based objective. For example, to realize the skill based objective, a member needs skill X, skill Y, and skill Z. Each of the skills needed to be acquired by a member within the last year to meet the current skill level needed. Based on an analysis of member A's skill data as presented on a skills map, Member A has acquired skill X and skill Y in the last year. In this example, analyzing engine (214-4) determines member A needs skill Z to meet the skill based objective. As a result, the analyzing engine (214-4) may determine member A needs to acquire skill Z. Since this type of evaluation may be conducted when an organization needs to identify which members need to gain a skill, this type of evaluation may be conducted at the discretion of an administrator.

The analyzing engine (214-4) may make an evaluation via determining how current a skill is for one member in relation to how current the same skill is for the other members. For example, to determine how current skill X for one member is in relation skill X for the other members, the analyzing engine (214-4) selects, from a skill map, skill X. The analyzing engine (214-4) determines, from the skill map, which of the members on the skills map have acquired skill X. The analyzing engine (214-4) determines how current skill X is for each of the members. This may be based on an average time since each of the members lasted used skill X. The average time may be in days, weeks, months, years, other measurements of time, or combinations thereof. This may further be based on when the member acquired the skill X. To further determine how current skill X is for each of the members, the analyzing engine (214-4) calculates a standard deviation with regard to how current skill X is for each of the members. If skill X is outside of a specific range of the standard deviation for a specific member, the analyzing engine (214-4) determines skill X for that specific member is not current. However, if skill X is inside of a specific range of the standard deviation for a specific member, the analyzing engine (214-4) determines skill X for that specific member is current. Since this type of evaluation may be conducted when an organization needs to identify a member with that need to update a skill, this type of evaluation may be conducted at the discretion of an administrator or on a quarterly basis.

The analyzing engine (214-4) may make an evaluation via assessing the likelihood for attaining related skills. For example, member C desires to acquire skill X. The administrator may want to know what is the likelihood of member C attaining skill X. The analyzing engine (214-4) finds a node corresponding to member C on the skills map and walks backwards from member C's node until it finds a node corresponding to skill X. For example, starting at member C's node, the analyzing engine (214-4) finds another node connected to member C's node. This node may be skill Y. The analyzing engine (214-4) then determines what nodes are connected to skill Y's node. Skill Y's node may be connect to member B. The analyzing engine (214-4) then determines what nodes are connected to member B's node. Member B's node may be connect to skill X and skill Z. As a result, member C is connect to skill X via skill Y and member B. Since there are a few nodes between member C and skill X, the evaluation may determine it is very likely that member C can obtain skill X. As a result, the generating engine (214-4) generates, via a recommendation, that member C would be an appropriate candidate for obtaining skill X. Since this type of evaluation may be conducted when a member wants to obtain a new skill, this type of evaluation may be conducted at the discretion of an administrator or the request of a member.

Alternatively, the analyzing engine (214-4) may determine which of the members would be a good candidate to mentor another member such that the other user acquires a specific skill. For example, the analyzing engine (214-4) may determine which member may be a candidate to help mentor member C such that member C may acquire skill X. The analyzing engine (214-4) may find skill X on the skills map as described above. Walking backwards as described above from skill X the analyzing engine (214-4) finds a member who already has acquired skill X. In this example, member B has acquired skill X. In some examples, information associated with member B may indicate that member B has already mentored another member in the past. As a result, the analyzing engine (214-4) may determine that member B would have the easiest time mentoring member C. Since this type of evaluation may be conducted when a members needs to be mentored, this type of evaluation may be conducted at the discretion of an administrator.

The analyzing engine (214-4) may make an evaluation to determine a talent analysis for each member. For example, the analyzing engine (214-4) may determine what the potential is for member A in two years. To determine what the potential for member A is in two years, the analyzing engine (214-4) analyzes the skills map to determine the skills and/or job titles associated with member A. This may include determining which nodes are connected to member A's node on the skills map. The analyzing engine (214-4) may determine, from the skills map, a job title such as level one engineer is connected to member A's node on the skills map. The analyzing engine (214-4) may identify job titles for other members and determine how long it took those members to reach a higher level than a level one engineer. For example, the analyzing engine (214-4) may determine which members are connected to job titles greater than level one engineer. In this example, member B's node is connected to a job title of level two engineer. Based on the skills map, the analyzing engine (214-4) determines members B became a level two engineer two years after becoming a level one engineer. The analyzing engine (214-4) may determine specific skills that member A needs to acquire to become a level two engineer by determine the skills connected to member B on the skills map. In keeping with the given example, the analyzing engine (214-4) may determine the potential for member A in two years is to become a level two engineer. This type of analysis may be done at based to an event. The event may include activing the analyzing engine (214-4) at the discretion of an administrator, at a specific time, when a member acquires a specific skill, when a member acquires a specific job role, when a member becomes a part of an organization, other events, or combinations thereof. Since this type of evaluation may be conducted when an organization needs to determine how to grow a career of the member, this type of evaluation may be conducted at the discretion of an administrator.

The analyzing engine (214-4) may use the skills map to make an evaluation to suggest skills training. The members may have indicated a future/desired job, or a desired skill which further informs the path to achieve that skill. The skills map may be similarly analyzed as described above to determining which skills a member may be trained for and ultimately acquire. This type of analysis may be done according to an event. The event may include at the discretion of an administrator, at a specific time, when a member needs to acquire a specific skill, when an organization needs member to fill a job role, when a member needs to train another member, other events, or combinations thereof.

As a result, the generating engine (214-5) generates, based on the evaluation, a recommendation regarding at least one of the members of the organization. The recommendation may be displayed via the display (204) of the user device (202). The recommendation may be in summary from. For example, the recommendation may state member B mentor member A for skill X. The recommendation may be in paragraph form. For example, the recommendation may state member B is available to mentor member A during time period X such that member A may acquire skill X.

While this example has been described with reference to the generating system analyzing all skills data and/or all members of the organization, a subset of historic data or a subset of an organization may be used for analysis by the generation system. The generating system may have a custom dictionary for the skills set or find the skills set through analysis of the organization.

An overall example of FIG. 2 will now be described. The identifying engine (214-1) identifies, based on an action of an administrator, members of an organization. The members may include member A, member B, and member C. The extracting engine (214-2) extracts skills data with a corresponding timeline from the databases (212) for each of the members of the organization to determine skills for each of the members. For example, the extracting engine (214-2) extracts skills data A1 (211-1), associated with timeline A1 (218-1), for member A. The extracting engine (214-2) extracts skills data B1 (211-2), associated with timeline B (218-2), for member B. The extracting engine (214-2) extracts skills data C (211-3), associated with date C (218-3), for member C. The creating engine (214-3) creates a skills map for the administrator, the skills map characterizing relationships between the members and the skills of the members. The analyzing engine (214-4) analyzes one of the skills associated with one of the members in relation to the skills map to make an evaluation. The evaluation may be based on a mentoring analysis for member A. The generating engine (214-5) generates, based on the evaluation, a recommendation. The recommendation may include having member B mentor member A such that member A obtains skill X. As a result, the skills data may provide the key to successful expertise location, performance evaluation and is the center of solutions from onboarding, recruitment, social learning solutions, performance and talent optimization for the organization.

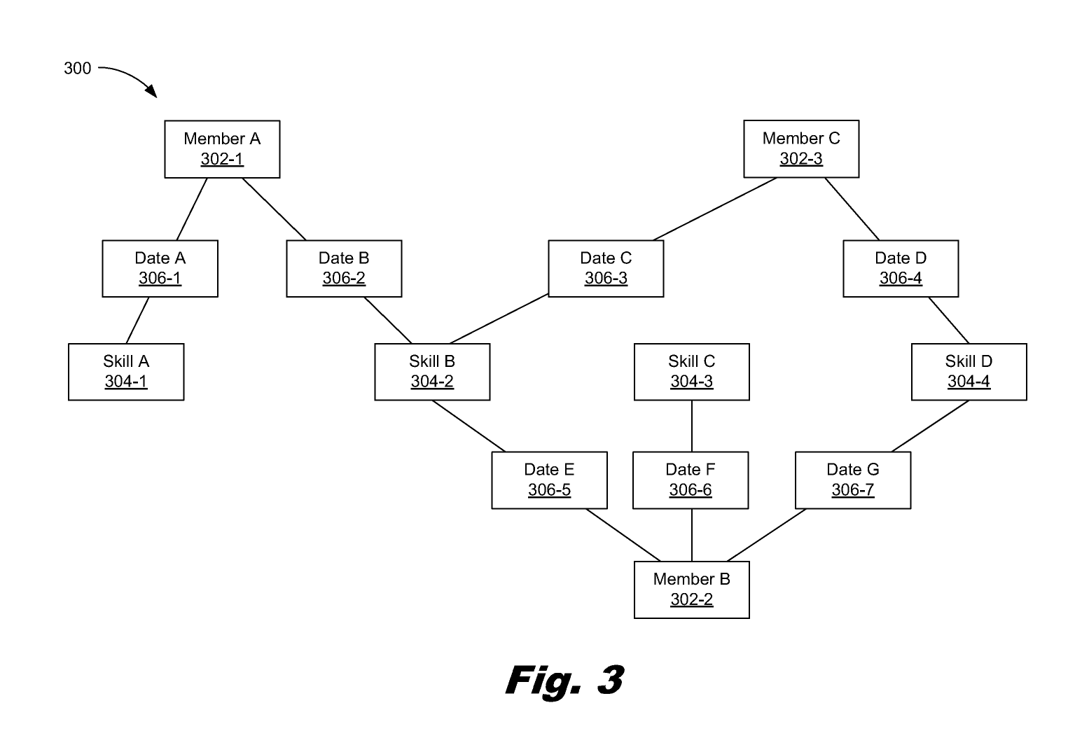

FIG. 3 is a diagram of an example of a skills map, according to one example of principles described herein. As will be described below, the skills map depicts members and skills as nodes. The relationship between the users and the skills are represented by an edge. The edge may include a timeline which corresponds to a date when the user acquired the skill.

An administrator, such as a HR leader for an organization, may access the generating system. The organization includes member A, member B, and member C. The administrator wants to analyze the skills for these members of the organization. The generating system is activated. The generating system retrieves the skills, job role, job title and date from the skills data as described above. The generating system may retrieve additional data elements such as skill levels.

The generating system creates a skills map (300) for the organization. As illustrated, the skills map (300) includes a number of skills (304) represented as nodes. The skills include skill A (304-1), skill B (304-2), skill C (304-3), and skill D (304-4). Skill A (304-1) may be technical writing. Skill B (304-2) may be negotiation. Skill C (304-3) may be programmer. Skill D (304-4) may be resiliency programming.

The skills map may include a number of members (302) represented as nodes. For example, the skills map (300) may include member A (302-1), member B (302-2), and member C (302-3).

Each of the members (302) may be associated with a skill (304). For example, member A (302-1) is associated with skill A (304-1) and skill B (304-2) as indicated by the edges represented as solid lines. The edges may be weighted based on how current each of the skills for each of the members is. For example, the weight of the edge is based on when the member lasted used a skill. In one example, the higher the weight, the thicker the solid line. In another example, the weight of the edge may be represented with text characters. For example, if an edge is associated a term such as “heavy,” that edge may be heavily weighted in subsequent analysis. Alternatively, the weight of the edge may be represented as a numeric range. For example, if an edge is associated with a number such as 10, that edge may be heavily weighted. If an edge includes a number such as 0, that edge may be lightly weighted.

Additionally, the skills map (300) may include dates (306). The dates (306) on the skill map (300) may indicate when the skills (304) were acquired by the members (302) and their job title. For example, date A (306-1) may indicate that member A (302-1) acquired skill A (304-1) on Jun. 20, 2000 and the job title is information technology (IT) intern. Date B (306-2) may indicate that member A (302-1) acquired skill B (304-2) on Jun. 20, 2014 and the job title is software engineer. Date C (306-3) may indicate that member C (302-3) acquired skill B (304-2) on Jun. 20, 2000 and the job title is software engineer. Date D (306-4) may indicate that member C (302-3) acquired skill D (304-4) on Apr. 20, 2000 and the job title is IT specialist. Date E (306-5) may indicate that member B (302-1) acquired skill B (304-2) on Mar. 20, 2014 and the job title is software engineer. Date F (306-6) may indicate that member B (302-1) acquired skill C (304-3) on Sep. 20, 2014 and the job title is senior software engineer. Date G (306-7) may indicate that member B (302-1) acquired skill D (304-4) on Apr. 20, 2014 and the job title is IT specialist.

The generating system analyzes each member (302) in relation to the created skills map (300). For example, member A (302-1) is selected on the skills map (300) by an administrator. The administrator may select member A (302-1) and initiate a potential talent analysis for member A (302-1). To determine the potential talent analysis for member A (302-1), the generating system determines how member A (302-1) and skills compares with the other members and their skills on the skills map (300). To do this, the generating system identifies member B (302-2) and member C (302-3) on the skills map (300). The generating system determines if member A (302-1) has any skills in common with member B (302-2) or member C (302-3). In this example, member A (302-1) has skill B (304-2) in common with member B (302-2) and member C (302-3). The generating system then determines what skills member B (302-2) and member C (302-3) have in common. As illustrated, member B (302-2) and member C (302-3) have skill D (304-4) in common. Since member A (302-1), member B (302-2), and member C (302-3) have skill B (304-2) in common, but not all of the members have skill D (304-4) in common, the generating system recommends, via a recommendation, that skill D (304-4) is a good fit for member A (302-1) to learn. Additionally, since member A (302-1) is a junior software engineer and member B (302-2) and member C (302-3) are senior software engineers, based on a similar analysis as described above, the generating system recommends, via a recommendation, that member A (302-1) could become a software engineer in the near future once skill D (304-4) is acquired by member A (302-1). The generating system can further determine since member B (302-2) and member C (302-3) have acquired skill D (304-4), that member B (302-2) or member C (302-3) are the best mentoring candidates for member A (302-1) such that member A (302-1) can acquire skill D (304-4). The generating system may leverage information as to the availability of member B (302-2) and member C (302-3) to determine if they are available to mentor member A (302-1). If the information indicates member B (302-2) is available to mentor member A (302-1), the generating system recommends, via a recommendation, that member B (302-2) can mentor member A (302-1) for skill D (304-4).

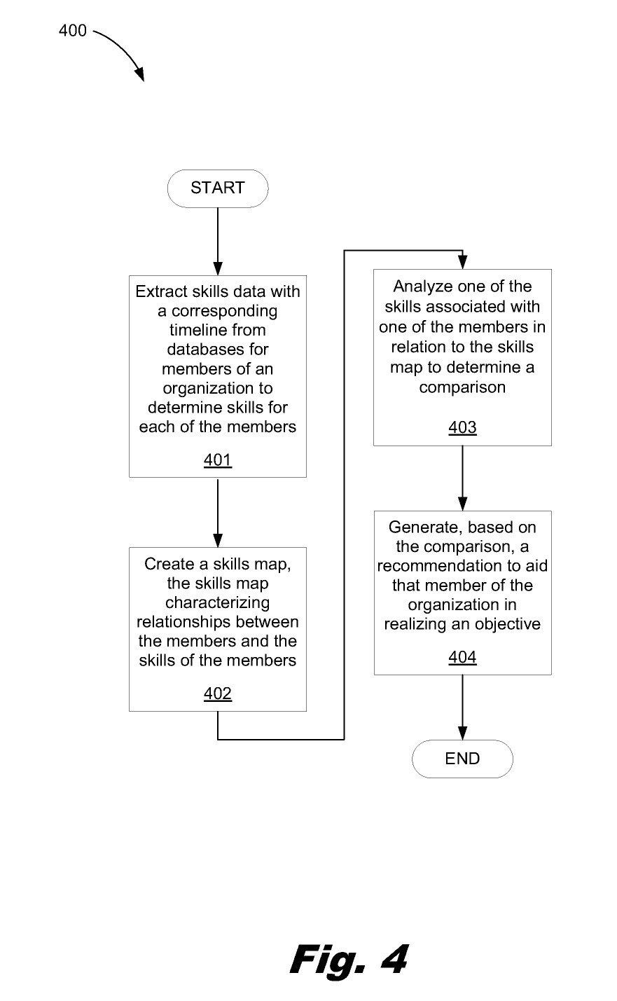

FIG. 4 is a flowchart of an example of a method for generating a recommendation regarding a member of an organization, according to one example of principles described herein. The method (400) may be executed by the system (100) of FIG. 1. The method (400) may be executed by other systems such as system 200, system 600, or system 700. In this example, the method (400) includes extracting (401) skills data with a corresponding timeline from databases for members of the organization to determine skills for each of the members, creating (402) a skills map, the skills map characterizing relationships between the members and the skills of the members, analyzing (403) one of the skills associated with one of the members in relation to the skills map to make an evaluation, and generating (404), based on the evaluation, a recommendation regarding at least one of the members of the organization.

As mentioned above, the method (400) includes extracting (401) skills data with a corresponding timeline from databases for members of an organization to determine skills for each of the members. The skills data may be extracted from databases such as a social media database, an HR database, a user profile database, a resume database, other databases, or combinations thereof. The skills data may be extracted for all members of an organization. The skills data may be extracted for specific members of the organization. The skills data may be extracted for each member that is used in a subsequent analysis by the method (400).

As mentioned above, the method (400) includes creating (402) a skills map, the skills map characterizing relationships between the members and the skills of the members. As mentioned above, the skills map depicts members and skills as nodes. The relationship between the users and the skills are represented by an edge. The edge may include a timeline which corresponds to a date when the user acquired the skill. A skills map may be created for all the members of the organization. The skills map may be created for specific members of the organization.

In other examples, the method (400) may user other methods and techniques instead of a skills map to characterize relationships between the members and the skills of the members. This may include using data structures to represent the relationships or databases that store information associated with the relationships.

As mentioned above, the method (400) includes analyzing (403) one of the skills associated with one of the members in relation to the skills map to make an evaluation. The evaluation may be used for a variety of purposes leading to a recommendation regarding the corresponding member of the organization. For example, the evaluation may be used for determining how current a skill is in relation to the other members, assessing the likelihood for attaining related skills, which of the members would be a good candidate for mentoring another member to acquire a specific skill, determining a talent analysis for each member, suggesting skills training, other evaluations, or combinations thereof. These evaluations may be made based on a time, an event, a selection, or combinations thereof. While specific examples have been given as to the types of evaluations, the method (400) may use any type of evaluation that may be appropriate

As mentioned above, the method (400) includes generating (404), based on the evaluation, a recommendation regarding at least one of the members of the organization. The recommendation may recommend that a member obtain a skill or mentor another member. The recommendation may recommend that a member improve a certain skill. For example, if a member is struggling with skill X, the recommendation may be to assign a mentor to help the member improve skill X. In some example, the recommendation may be displayed to an administrator via a GUI. While specific examples have been given to the types of recommendations, the method (400) may generate any recommendation that may be appropriate.

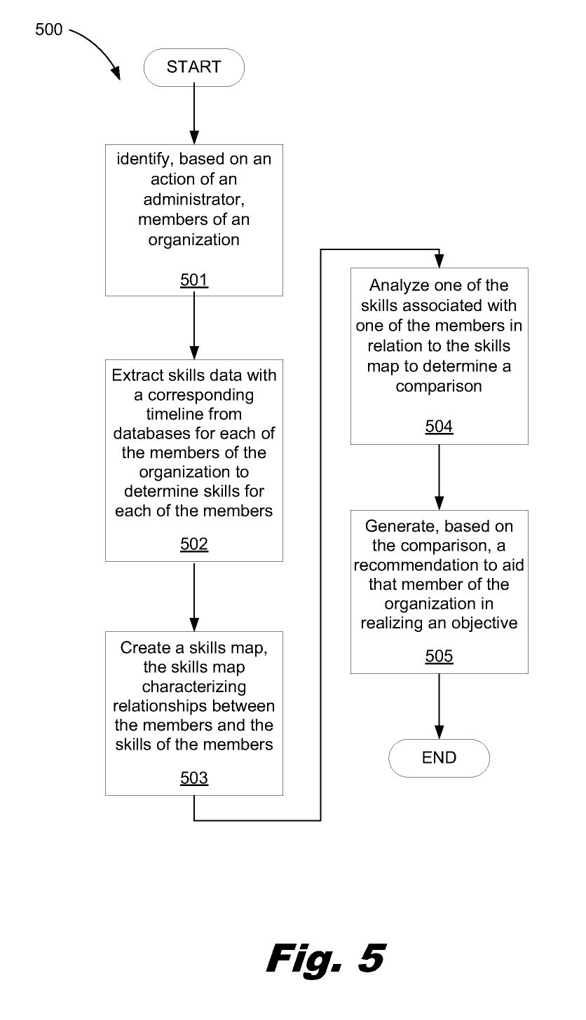

FIG. 5 is a flowchart of an example of a method for generating a recommendation regarding a member of an organization, according to one example of principles described herein. The method (500) may be executed by the system (100) of FIG. 1. The method (500) may be executed by other systems such as system 200 system 600 or system 700. In this example, the method (500) includes identifying (501), based on an action of an administrator, members of an organization, extracting (502) skills data with a corresponding timeline from databases for members of an organization to determine skills for each of the members, creating (503) a skills map, the skills map characterizing relationships between the members and the skills of the members, analyzing (504) one of the skills associated with one of the members in relation to the skills map to make an evaluation, and generating (505), based on the evaluation, a recommendation regarding at least one of the members of the organization.

As mentioned above, the method (500) includes identifying (501), based on an action of an administrator, members of an organization. In an example, an action may be the administrator clicking on a menu item on a GUI for their organization. In other examples, the action may be an event. Such an action may be based on job changes of the members, attrition, onboarding, or other events that changes the structure of the organization. The method (500) may allow an administrator to utilize a search query with specific search parameters to identify a group of members for analysis.

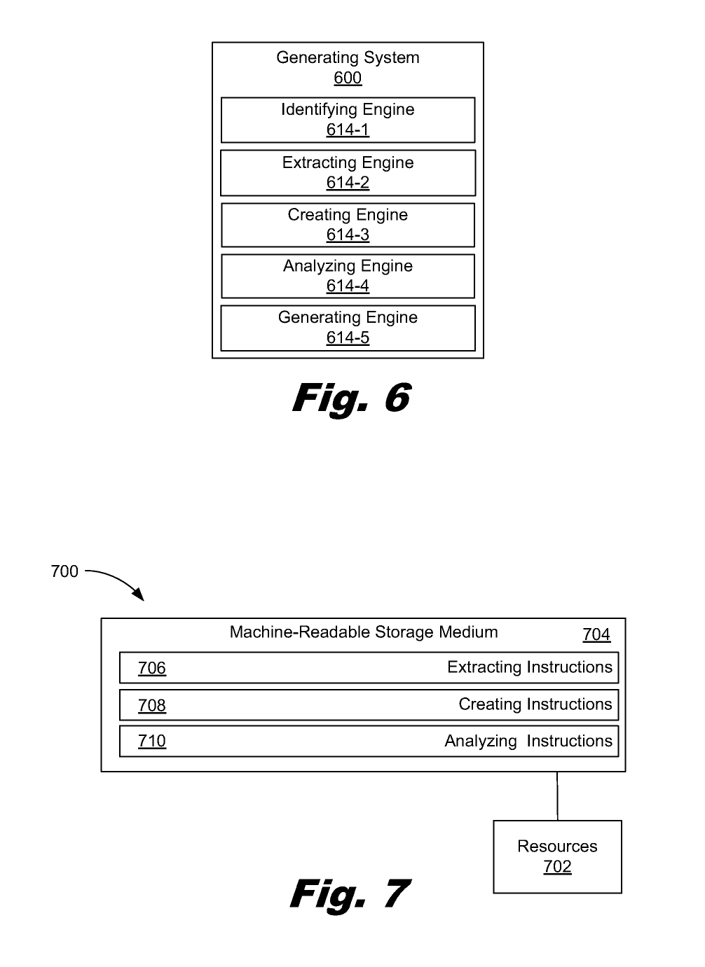

FIG. 6 is a diagram of an example of a generating system, according to the principles described herein. The generating system (600) includes an identifying engine (614-1), an extracting engine (614-2), a creating engine (614-3), an analyzing engine (614-4), and a generating engine (614-5). The engines (614) refer to a combination of hardware and program instructions to perform a designated function. Alternatively, the engines (614) may be implemented in the form of electronic circuitry (e.g., hardware). Each of the engines (614) may include a processor and memory. Alternatively, one processor may execute the designated function of each of the engines (614). The program instructions are stored in the memory and cause the processor to execute the designated function of the engine.

The identifying engine (614-1) identifies, based on an action of an administrator, members of an organization. The identifying engine (614-1) identifies, based on one action, at least two members of the organization. The identifying engine (614-1) identifies, based on several actions, at least two members of the organization.

The extracting engine (614-2) extracts skills data with a corresponding timeline from databases for members of an organization to determine skills for each of the members. The extracting engine (614-2) extracts skills data with one corresponding timeline from databases for members of an organization to determine skills for each of the members. The extracting engine (614-2) extracts skills data with several corresponding timelines from databases for members of an organization to determine skills for each of the members.

The creating engine (614-3) creates a skills map, the skills map characterizing relationships between the members and the skills of the members. The creating engine (614-3) creates one skills map for one administrator. The creating engine (614-3) creates several skills maps for several administrators.

The analyzing engine (614-4) analyzes one of the skills associated with one of the members in relation to the skills map to make an evaluation. The analyzing engine (614-4) analyzes one of the skills associated with one of the members in relation to the skills map to make one evaluation. The analyzing engine (614-4) analyzes one of the skills associated with one of the members in relation to the skills map to make several evaluations.

The generating engine (614-5) generates, based on the evaluation, a recommendation regarding at least one of the members of the organization. The generating engine (614-5) generates, based on the evaluation, one recommendation. The generating engine (614-5) generates, based on the evaluation, several recommendations.

FIG. 7 is a diagram of an example of a generating system, according to the principles described herein. In this example, the generating system (700) includes resource(s) (702) that are in communication with a machine-readable storage medium (704). Resource(s) (702) may include one processor. In another example, the resource(s) (702) may further include at least one processor and other resources used to process instructions. The machine-readable storage medium (704) represents generally any memory capable of storing data such as instructions or data structures used by the generating system (700). The instructions shown stored in the machine-readable storage medium (704) include extracting instructions (706), creating instructions (708), and analyzing instructions (710).

The machine-readable storage medium (704) contains computer readable program code to cause tasks to be executed by the resource(s) (702). The machine-readable storage medium (704) may be tangible and/or physical storage medium. The machine-readable storage medium (704) may be any appropriate storage medium that is not a transmission storage medium. A non-exhaustive list of machine-readable storage medium types includes non-volatile memory, volatile memory, random access memory, write only memory, flash memory, electrically erasable program read only memory, or types of memory, or combinations thereof.

The extracting instructions (706) represents instructions that, when executed, cause the resource(s) (702) to extract skills data with a corresponding timeline from databases for members of an organization to determine skills for each of the members. The creating instructions (708) represents instructions that, when executed, cause the resource(s) (702) to create a skills map, the skills map characterizing relationships between the members and the skills of the members. The analyzing instructions (710) represents instructions that, when executed, cause the resource(s) (702) to analyze one of the skills associated with one of the members in relation to the skills map to make an evaluation.

Further, the machine-readable storage medium (704) may be part of an installation package. In response to installing the installation package, the instructions of the machine-readable storage medium (704) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the resource(s) (702) and the machine-readable storage medium (704) are located within the same physical component, such as a server, or a network component. The machine-readable storage medium (704) may be part of the physical component's main memory, caches, registers, non-volatile memory, or elsewhere in the physical component's memory hierarchy. Alternatively, the machine-readable storage medium (704) may be in communication with the resource(s) (702) over a network. Further, the data structures, such as the libraries, may be accessed from a remote location over a network connection while the programmed instructions are located locally. Thus, the generating system (700) may be implemented on a user device, on a server, on a collection of servers, or combinations thereof.

The generating system (700) of FIG. 7 may be part of a general purpose computer. However, in alternative examples, the generating system (700) is part of an application specific integrated circuit.

The preceding description has been presented to illustrate and describe examples of the principles described. This description is not intended to be exhaustive or to limit these principles to any precise form disclosed. Many modifications and variations are possible in light of the above teaching.

The flowchart and block diagrams in the figures illustrate the architecture, functionality, and operations of possible implementations of systems, methods, and computer program products. In this regard, each block in the flowchart or block diagrams may represent a module, segment, or portion of code, which has a number of executable instructions for implementing the specific logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration and combination of blocks in the block diagrams and/or flowchart illustration, can be implemented by special purpose hardware-based systems that perform the specified functions or acts, or combinations of special purpose hardware and computer instructions.

The terminology used herein is for the purpose of describing particular examples, and is not intended to be limiting. As used herein, the singular forms “a,” “an” and “the” are intended to include the plural forms as well, unless the context clearly indicated otherwise. It will be further understood that the terms “comprises” and/or “comprising” when used in the specification, specify the presence of stated features, integers, operations, elements, and/or components, but do not preclude the presence or addition of a number of other features, integers, operations, elements, components, and/or groups thereof.

1-7. (canceled)

8. A system for generating a recommendation regarding a member of an organization, the system comprising:
a processor;
computer program code, communicatively coupled to the processor, the computer program code comprising:
an extracting engine to extract skills data with a corresponding timeline from a database for members of the organization to determine skills for each of the members;
a creating engine to create a skills map, the skills map illustrating relationships between the members and the skills of the members;
an analyzing engine to analyze one of the skills associated with one of the members in relation to the skills map to make an evaluation; and
a generating engine to generate, based on the evaluation, a recommendation regarding at least one of the members of the organization.

9. The system of claim 8, wherein the members of the organization and the skills for each of the members are represented as nodes and the relationship between the members and the skills are represented as weighted edges on the skills map.

10. The system of claim 8, wherein the skills map comprises weighted edges to indicate how current each of the skills is for each of the members.

11. The system of claim 8, wherein the evaluation is made based on a time, an event, or combinations thereof.

12. The system of claim 8, further comprising an identifying engine to identify which the members of the organization to include in the skills map based on factors, the factors comprising any of personal development, career development, an interest, business needs, a team strategy, a job role, and an expertise.

13. The system of claim 8, wherein the creating engine creates the skills map by:
identifying relationships between the members; and
updating the skills map to include the relationships.

14. A machine-readable storage medium encoded with instructions for generating a recommendation regarding a member of an organization, the instructions executable by a processor of a system to cause the system to:
extract skills data, including a timeline, from a database for members of an organization to determine skills for each of the members relative to the timeline;
analyze skills associated with a number of the members in relation to skills of other members of the organization to generate an analysis; and
generate a recommendation regarding a specific member of the organization based on the analysis.

15. The machine-readable storage medium of claim 14, wherein the recommendation identifies a skill that the specific member is positioned to acquire or improve.

16. The machine-readable storage medium of claim 14, further comprising instructions that, when executed, cause the processor to generate a skills map showing both skills and members of the organization as nodes and illustrating relationships between organization members and skills with edges.

17. The machine-readable storage medium of claim 16, wherein the edges are weighted edges on the skills map.

18. The machine-readable storage medium of claim 17, wherein the weighted edges are weighted to indicate how current each of the skills for each of the members is.

19. The machine-readable storage medium of claim 14, further comprising instructions that, when executed, cause the processor to prompt a user to identify members in the organization to include in the analysis and a member about whom the recommendation is to be generated.

20. The machine-readable storage medium of claim 16, further comprising instructions that, when executed, cause the processor to update the skills map to include relationships between members of the organization.
